(19) United States
(12) Patent Application Publication
(10) Pub. No.: US 2024/0359418 A1
(43) Pub. Date: Oct. 31, 2024

(54) CONVERTING MACHINE AND CORRESPONDING SYSTEM

(71) Applicant: BOBST LYON, Bron (FR)

(72) Inventor: Olivier ROBIN, Anjou (FR)

(73) Assignee: BOBST LYON, Bron (FR)

(21) Appl. No.: 18/684,023

(22) PCT Filed: Aug. 23, 2022
(86) PCT No.: PCT/EP2022/073492

§ 371 Date: Feb. 15, 2024

(30) Foreign Application Priority Data
Aug. 23, 2021 (EP) 21315140.0

(51) Int. Cl. B31B 50/14; B31B 50/00; B31B 50/20; B31B 50/25

(52) U.S. Cl. CPC B31B 50/146; B31B 50/006; B31B 50/20; B31B 50/256

(57) ABSTRACT

The invention relates to converting machine (10) for producing flat-packed or folding of boxes (1″) from sheets (1), the converting machine being configured to transport the sheets in a direction of transportation (T). The converting machine comprises a first printing module (16) configured to print on one of a first side and a second side of the sheet (1) and a die-cutting module (18) comprising a tool-holder cylinder configured to connect to a die-cutting tool and a counter-cylinder, the die-cutting module being configured to apply cut lines to the first side of the sheet. The machine further comprises a separate scoring module (19) having a scoring tool configured to apply crease lines on a second side of the sheet.

### FIELD OF THE INVENTION

The present invention relates to a converting machine for producing flat-packed or folding boxes. In particular, the invention relates to a scoring and die-cutting module of a converting machine.

### BACKGROUND OF THE INVENTION

Converting machines comprising rotary die cutters can be configured to produce flat-packed or folding boxes. These converting machines are fed with sheets which are printed, cut and scored to form blanks which can subsequently be folded and assembled into three-dimensional boxes. The blanks are designed to be folded either manually or automatically in a folder-gluer machine.

The boxes often need to be provided with a printed motif or pattern on its outside surface, the inside surface or on both the inside and outside surfaces.

A machine operator is thus required to adapt the configuration of the converting machine between different jobs. Sometimes the sheets must be turned in order to print on both the inside and the outside surfaces of the box.

It is often required to change the configuration of several modules in the converting machine when the type of boxes change, whereby the printing plates and the die-cutting tools defining cutout shapes and crease lines are changed. Sometimes, it is also needed to change the anilox cylinders in order to obtain a higher resolution or a higher ink supply and better adapt to the paper or cardboard surface qualities.

The outside surface of the boxes is oftentimes of paramount importance. However, for other purposes such as boxes for mail order and online shopping, it can be advantageous to provide the box with a discrete outer surface and instead a more sophisticated printed inside surface.

Hence, there is a need to provide a flexible way of printing on the inside and the outside surfaces of the boxes with a converting machine, while reducing the need for changing the tooling as the characteristics of the boxes change.

### SUMMARY

In view of the above-mentioned problems, it is an object of the present invention to provide a versatile machine, which is able to apply inside and outside printed motifs on the boxes.

According to a first aspect of the present invention, there is provided a converting machine for producing flat-packed or folding of boxes from sheets, the converting machine being configured to transport the sheets in a direction of transportation and wherein the converting machine comprises:
a first printing module configured to print on one of a first side and a second side of the sheet,
a die-cutting module comprising a counter-cylinder and a tool-holder cylinder configured to connect to a first die-cutting tool provided with cutting edges, and the die-cutting module being configured to apply cut lines to the first side of the sheet,
wherein the converting machine further comprises a scoring module comprising a counter cylinder and tool-holder cylinder configured to connect to a scoring tool provided with creasing edges, the scoring module being configured to apply crease lines on a second side of the sheet.

The present invention is based on a realization that a versatile converting machine can be provided if configured apply crease lines and cut lines on either side of the sheet.

The first die-cutting tool may be configured to only apply cut lines. The scoring module may be separate from the die-cutting module.

In an embodiment, the tool-holder cylinder of the die-cutting module is further configured to connect to a second die-cutting tool configured to apply cut lines and crease lines on the first side of the sheet. The die-cutting module may thus be selectively configured to further provide crease lines on the first side of the sheet, such that the crease lines can be applied on either side of the sheet.

Hence, the second tool is configured to both provide cut lines and creasing lines to the sheet.

In an embodiment, the scoring module can be disabled and the die-cutting module is further configured to connect to a second die-cutting tool which is configured to apply cut lines and crease lines onto the first side of the sheet, such that crease lines can be applied on either side of the sheet.

Disabled means that the creasing tool is not in contact with the sheet. This can mean that the creasing tool is removed from the tool-holder cylinder. Alternatively, the creasing tool is moved away from the sheet.

In an embodiment, the die-cutting module is located downstream of the scoring module in the direction of transportation. In such a way, the cutting away of debris can be performed after the scoring operation.

In an embodiment, the scoring module comprises a structural frame having a first side frame portion and a second side frame portion, and wherein the side frames portions are configured to receive shafts of the tool-holder cylinder and the counter cylinder.

In an embodiment, tool-holder cylinder of the die-cutting module is located vertically above a transportation path of the sheet.

In an embodiment, the tool-holder cylinder of the scoring module is located vertically below the transportation path of the sheet.

The tool-holder cylinder of the die-cutting module can thus be located vertically above the counter-cylinder of the die-cutting module. Consequently, the tool-holder cylinder of the scoring module can be located vertically below the counter cylinder of the scoring module.

In an embodiment, the tool-holder cylinder of the scoring module comprises attachment brackets for attaching the scoring tool. The scoring tool can be a die in the form of a sleeve, configured to be attached around a circumferential surface of the tool-holder cylinder. In an embodiment, the scoring tool only comprises creasing edges.

The counter-cylinder of the scoring module may be provided with a resilient surface material configured to contact the creasing edges of the scoring tool.

In an embodiment, the first printing module is a flexographic printing module configured to print on bottom surface of the sheet.

In another embodiment, the first printing module is a flexographic printing module configured to print on top surface of the sheet.

The first printing module may be an ink-jet printing module.

In an embodiment, the converting machine further comprises a second printing module configured to print on a second side of the sheet, which is different from the side of the sheet printed by the first printing module.

In an embodiment, the converting machine further comprises a third printing module configured as an inkjet printing module, and which is preferably configured to print on a top surface of the sheet.

In an embodiment, the converting machine further comprises a conveying system comprising a plurality of vacuum transfers and a cutting and scoring register control system, the cutting and scoring register control system comprising a first sensor and a second sensor, a control unit and a memory,
and wherein the first sensor is located upstream of the scorer module at a first sensor position and the second sensor is located upstream of the die-cutting module at a second sensor position,
wherein the cutting and scoring register control system is configured to determine from a detection time provided by the first sensor, an actual scorer position of a front leading edge of the sheet at the first sensor position and define said actual position as an initial reference position for the sheet, the system being further configured to determine based on the initial reference position, a corresponding die-cutter reference position for the front leading edge at the second sensor location,
and wherein the control unit is configured to retrieve a detection time of the front leading edge from the second sensor and determine an actual position of the front leading edge of the sheet at the second sensor location and, wherein the control unit is configured to determine a displacement distance from the difference between the actual die-cutter position and the die-cutter reference position, the control unit being further configured to modify the speed of the at least one vacuum transfer to provide a longitudinal position correction to the sheet between the scoring module and die-cutting module.

The invention also relates to a system comprising:
a converting machine comprising a first printing module configured to print on one of a first side and a second side of the sheet,
a die-cutting module comprising a counter-cylinder and a tool-holder cylinder,
a scoring module comprising a counter cylinder and tool-holder cylinder,
a first die-cutting tool configured to connect to the tool-holder cylinder of the die-cutting module and wherein the first die-cutting tool is only provided with cutting edges,
a second die-cutting tool configured to connect to the tool-holder cylinder of the die-cutting module and wherein the second die-cutting tool is provided with cutting edges and creasing edges,
a first scoring tool configured to connect to the tool-holder cylinder of the scoring module and provided with creasing edges.

In an embodiment, the first printing module is configured to print on the first side of the sheet and wherein the system further comprises a second printing module configured to print on the second side of the sheet.

### BRIEF DESCRIPTION OF THE DRAWINGS

The invention will now be described by way of example and with reference to embodiments shown in the enclosed drawings, where the same reference numerals will be used for similar elements and in which:

FIGS. 1a and 1b show a flat-packed box and a folded box obtainable from the flat-packed box;

FIG. 1c illustrates a sheet substrate to be used in the production of a flat-packed box;

FIG. 2 is a schematic perspective view of a converting machine in the form of a rotary die-cutter;

FIG. 3 is a schematic perspective view of a part of a conveying system of a converting machine;

FIGS. 4a to 4d are schematic cross-sectional views of converting machines according to embodiments of the present invention;

FIG. 5 is a schematic perspective view of a flexographic printing assembly;

FIG. 6a is a schematic perspective view of a die-cutting module;

FIG. 6b is a schematic perspective and partly cut-away view of the die-cutting module of FIG. 6a when equipped with a first tool;

FIG. 6c is a schematic perspective and partly cut-away view of the die-cutting module of FIG. 6a when equipped with a second tool;

FIG. 7a is a schematic perspective view of a creasing module according to an embodiment of the present invention;

FIG. 7b is a schematic perspective and partly cut-away view of the creasing module of FIG. 7a;

FIGS. 8a to 8d are schematic cross-sectional views of converting machines according to embodiments of the present invention;

FIG. 9 is a schematic diagram illustrating an exemplary register displacement of a sheet in the cutting and creasing modules; and

FIG. 10 is a schematic diagram of a register control system in an embodiment of the present invention.

### DETAILED DESCRIPTION

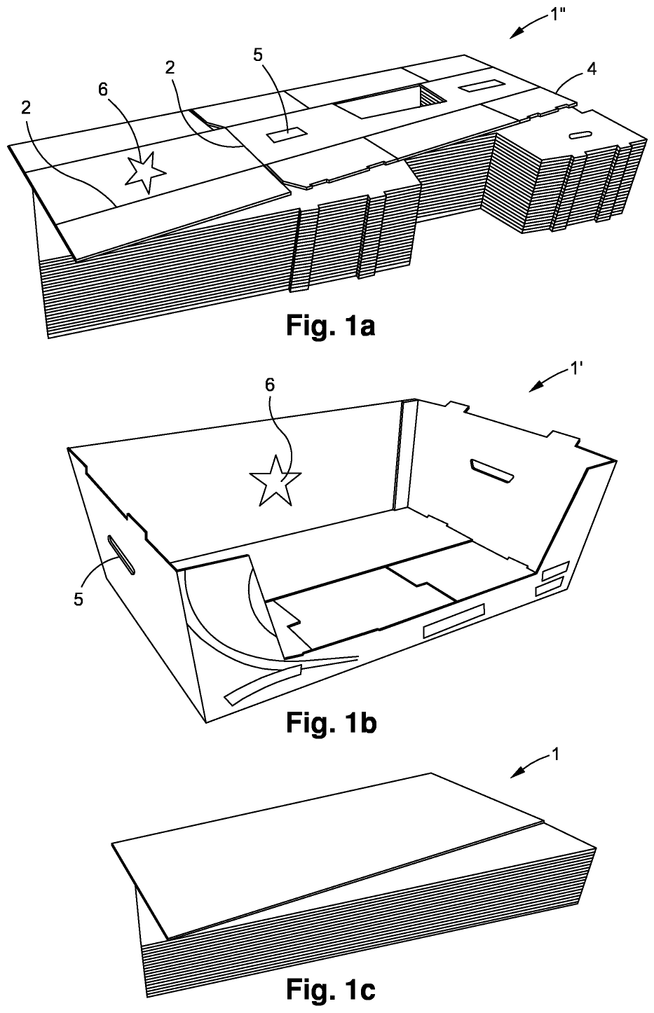

Now referring to FIGS. 1a and 1b, which illustrate an example of a flat-packed box 1″ and a box 1′ obtained from the flat-packed box 1″ after folding. As seen in the figures, the flat-packed box 1″ comprises crease lines 2 which enable folding, cut exterior edges 4 which provide the overall shape to the box 1′, and may further comprise cut-outs 5 (e.g. for handles). The flat-packed box 1″ is obtained from a sheet substrate 1, such as the one illustrated in FIG. 1c. The sheet substrate 1 is a square or rectangular sheet and can be made from of cardboard or paperboard.

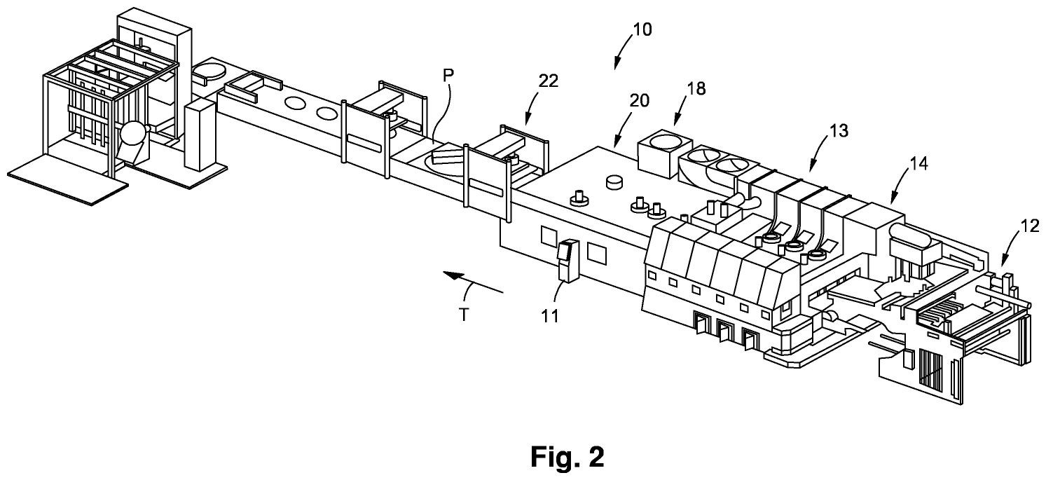

The flat-packed box 1″ of FIG. 1a is provided with a printed motif 6 on one side and can be produced in a converting machine 10, such as the one illustrated in FIG. 2. The converting machine 10 illustrated in FIG. 2 is in the configuration of a rotary die-cutter machine 10. At an entry position of the converting machine 10, a sheet substrate 1 is placed in a feeder module 14 and is transported in a direction of transportation T through the converting machine 10 in order to undergo a series of operations which print, cut and crease the sheet substrate 1. The direction of transportation T is defined from the inlet to the outlet of the converting machine 10. The sheet 1 is transported along a transportation path P, which can be defined as the trajectory of the sheet 1 through the converting machine 10.

From the inlet of the converting machine 10 and in a downstream direction along the direction of transportation T, the converting machine 10 may comprise a prefeeder 12, a feeder module 14, printing section 13 comprising a plurality of printing modules, a die-cutting module 18, a bundle stacker module 20 and a palletizer-breaker 22. A main operator interface 11 may also be provided in the proximity of the converting machine 10.

The sheet 1 thus undergoes a transformation to become a blank and then a flat packed box. The sheet 1 may comprise a plurality of juxtaposed blanks which are joined together by frangible lines. These lines can be ruptured in the palletizer-breaker module 22 to obtain the separate flat-packed boxes 1″. This is for instance described in documents EP3934902 A1 and EP3445549 A1.

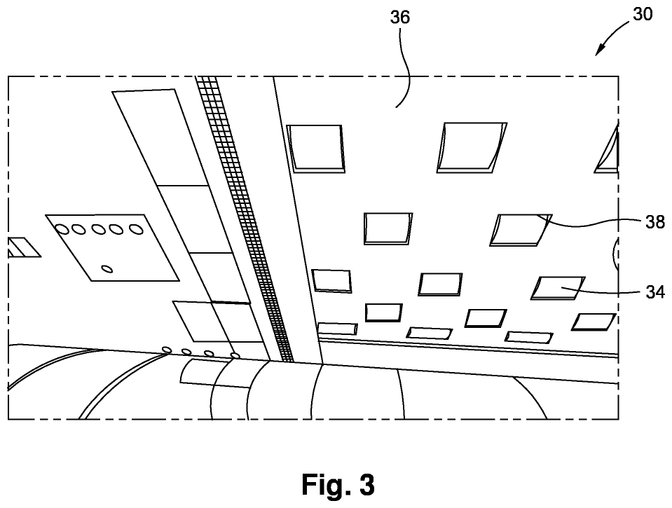

As best seen in FIGS. 3, 4a to 4b, and 8a the converting machine 10 comprises a conveying system 30 configured to transport the sheet 1 through the converting machine 10 in the direction of transportation T. The conveying system 30 may comprise a plurality of separate transportation segments 32, referred to as transfer units 32. In particular, the conveying system 30 may comprise a plurality of transfer units 32 in the configuration of vacuum transfers 32. The vacuum transfers 32 comprise a transportation surface 36, drive elements such as endless belt conveyors and rollers 34 to convey the sheet 1 through the converting machine 10. The vacuum transfer 32 are operationally connected to transfer drive motors 33 which drive the rollers 34. The rollers drive the sheet 1 forward in the direction of transportation T. Vacuum apertures 38 are arranged around the rollers 34 to ensure that the sheet is adhered against the rollers 34.

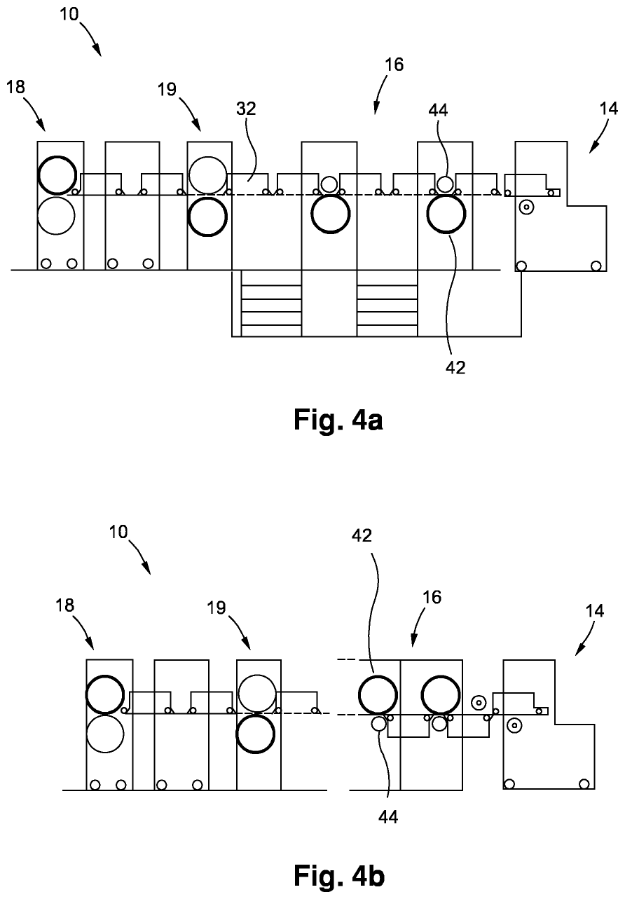

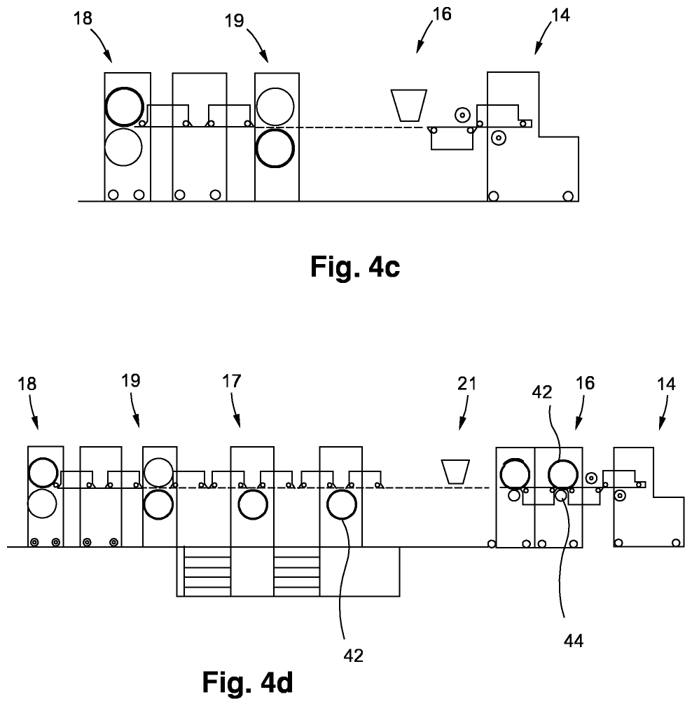

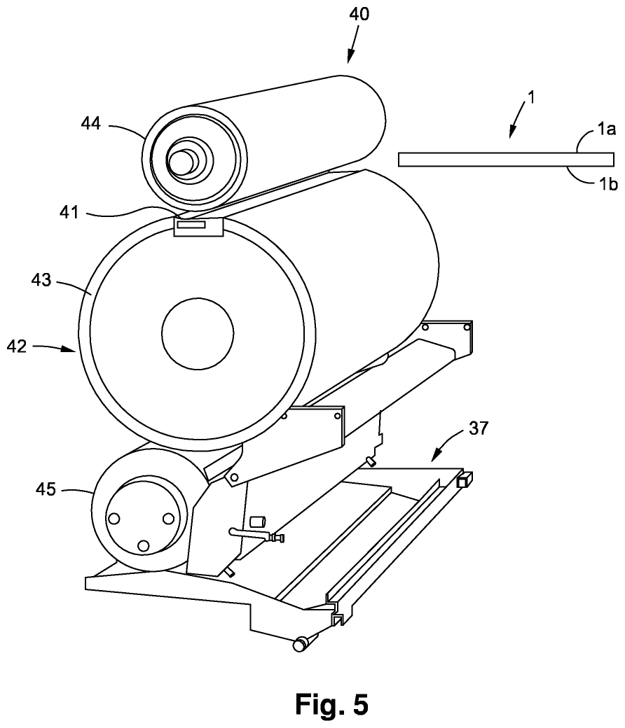

Now referring to FIGS. 4a to 4d, which illustrate embodiments of a converting machine 10 according to the present invention. The converting machine 10 is configured similar to the converting machine of FIG. 2 and comprises a first printing module 16 and a die-cutting module 18. However, in the illustrated embodiment of FIGS. 4a to 4d, the optional bundle-stacker module 20 and palletizer-breaker 22 are not shown. Additionally, the converting machine 10 further comprises a scoring module 19, which is separate from the die-cutting module 18. Common to all embodiments illustrated in FIGS. 4a to 4d, the scoring module 19 is located between a printing module 16, 17, 21 and the die-cutting module 18. Hence, according to the present invention, the scoring and the die-cutting operations on the sheet 1 may be separately performed in different modules.

As illustrated in FIGS. 4a and 5, the first printing module 16 can configured to print on a bottom side 1b of the sheet 1. The first printing module 16 can thus be a flexographic printing module 16 configured to print on the bottom side 1b of the sheet 1. The first printing module 16 comprises at least one printing assembly 40 provided with a printing cylinder 42 located vertically below a counter cylinder 44. In such a way, the sheet 1 passes between the counter cylinder 44 and the printing cylinder 42, which prints on the bottom side 1b of the sheet 1.

The flexographic printing assembly 40 comprises a printing cylinder 42 having an attachment bracket 41 onto which a printing plate 43 can be mounted. The printing plate 43 is provided with a printing die which has been configured for printing a specific motif on the sheet 1. In the illustrated configuration, the printing cylinder 42 is pressed against a bottom side 1b of the sheet 1. An anilox cylinder 45 is arranged in the proximity of the printing cylinder 42 and is configured to absorb and transfer ink from a liquid supply device 37, such as a doctor blade chamber 37.

Alternatively, as illustrated in FIG. 4b, the first printing module 16 can be configured to print on a top side 1a of the sheet 1. The first printing module 16 may be a flexographic printing module. The first printing module 16 is thus provided with at least one printing cylinder 42 located vertically above a counter cylinder 44.

Alternatively, as illustrated in FIG. 4c, the first printing module 16 can be a digital inkjet printing module configured to print on the top side 1a of the sheet 1.

In a preferred embodiment and as illustrated in FIG. 4d, the converting machine 10 comprises a first printing module 16 configured to print on a top side 1a of the sheet 1 and a second printing module 17 configured to print on a bottom side 1b of the sheet 1. The second printing module 17 can be located downstream of the first printing module 16 in the direction of transportation T. Optionally, the converting machine 10 may further comprise a third printing module 21 in the form of an inkjet printing module 21. The inkjet printing module 21 is preferably configured to print on a top side 1a of the sheet 1. The printing modules 16, 17 and 21 form together a printing section 13 in the converting machine 10.

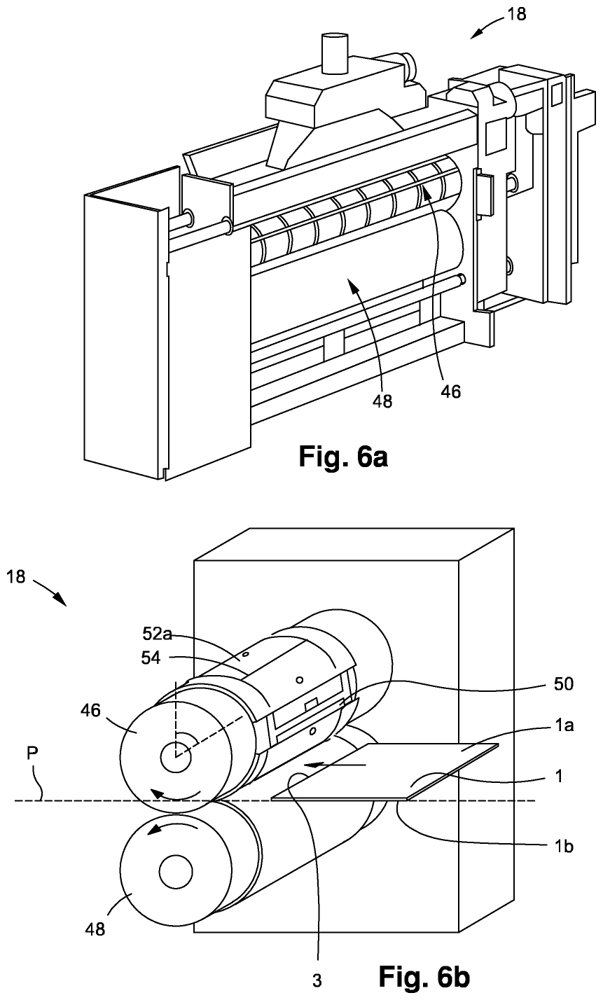

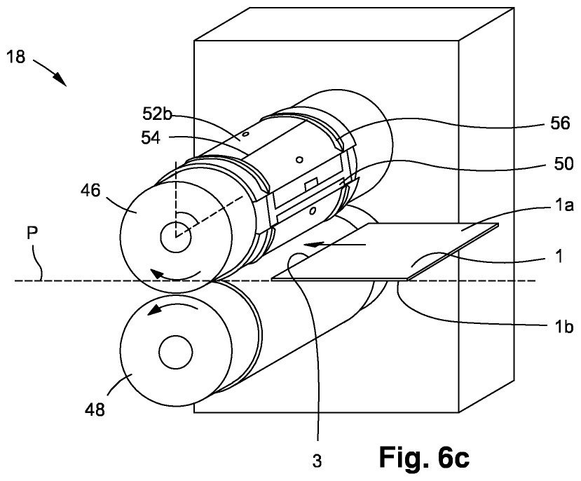

As best seen in FIGS. 6a and 6b, the die-cutting module 18 comprises a tool-holder cylinder 46 and a counter cylinder 48. The tool-holder cylinder 46 of the die-cutting module 18 is provided with attachment brackets 50 configured to engage with different tools 52 in the form of dies 52. As illustrated in FIG. 6b, a first type of tools 52a may be provided only with cutting edges 54. The cutting edges 54 are configured to apply cut lines to the sheet 1. However, as illustrated in FIG. 6c, it is also possible to attach a second type of tools 52b to the die-cutting module 18. The second type of tools 52b may be in the form of cutting and scoring dies 52b, which perform both cutting and scoring operations on the sheet 1. Such combined cutting and scoring dies 52b comprise cutting edges 54 and creasing edges 56.

Hence, the tools 52 may thus comprise a first tool 52a only provided with cutting edges 54, and a second tool 52b provided with cutting edges 54 and creasing edges 56. The second tool 52a may thus be configured to form all the cuts and crease lines on the sheet 1.

Preferably, the tool-holder cylinder 46 of the die-cutting module 18 is located vertically above its cooperating counter cylinder 48. This enables cut-away waste parts from the sheet 1 to fall below the transportation path P by the impact of gravity.

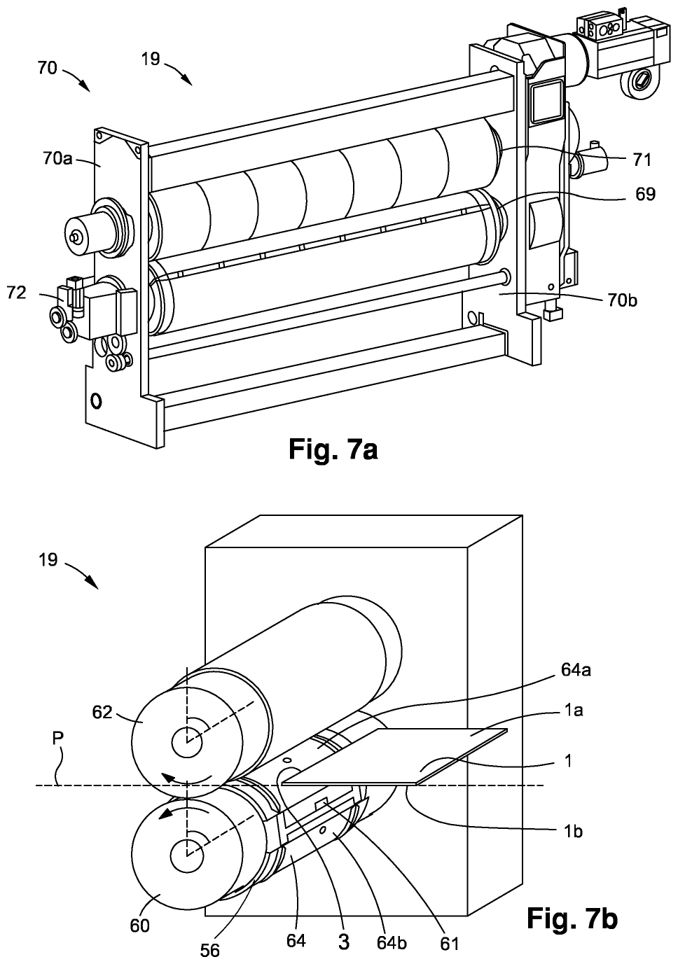

As illustrated in FIGS. 7a and 7b, the scoring module 19 comprises a tool-holder cylinder 60 and a counter cylinder 62. The scoring module 19 comprises a structural frame 70 having a first side frame portion 70a and a second side frame portion 70b, each configured to receive shafts 69 of the tool-holder cylinder 60 and shafts 71 of the counter cylinder 62.

The tool-holder cylinder 60 and the counter cylinder 62 may be driven at the same or similar tangential speed in opposite rotational directions. In order to drive the tool-holder cylinder 60 and the counter cylinder 62, a motor 72 can be provided on one side of the first and second side-frames 70a, 70b.

The tool-holder cylinder 60 is provided with at least one attachment bracket 61 for attaching a scoring tool 64 in the form of a scoring die 64. The scoring die 64 is preferably a cylindrical tubular sleeve.

The scoring tool 64 is provided with creasing edges 56 which are configured to apply crease lines on the sheet 1.

In a preferred embodiment, the scoring die 64 can be in the form of two half-shells 64a, 64b. This enables mounting of the scoring die 64 around the tool-holder cylinder 60 without dismantling the tool-holder cylinder 60 from the structural frame 70. The counter cylinder 62 may have a resilient surface, such as polymeric surface made from rubber or like. In an embodiment, the scoring die 64 may be in the form of a cutting and scoring die, which perform both cutting and scoring operations on the sheet 1.

In an embodiment, the scoring die 64 may be configured to additionally provide perforation lines to the sheet 1. The perforation lines are frangible lines which partially separate juxtaposed blanks on the sheet 1. The blanks can be separated from each other when the frangible lines are ruptured.

The tool-holder cylinder 60 of the scoring module 19 and the tool-holder cylinder 46 of the die-cutting module 18 are located on opposite sides of the transportation path P of the sheet 1. Hence, the scoring die 64 of the scoring module 19 and the cutting die 52 of the die-cutting module 18 are pressed against different sides of the sheet 1.

The scoring module 19 can be disabled such that no deformative operation is performed against the sheet 1. This can be done by removing the scoring die 64 and optionally replacing it with a traction tool. When the scoring module 19 is disabled, the die-cutting module 18 can be configured to perform both scoring and die-cutting operations on the sheet 1. The die-cutting module 18 can thus be provided with a second tool 52b comprising both cutting edges 54 and creasing edges 56.

When enabled, the scoring module 19 can be configured to perform scoring operations on the sheet 1, while the die-cutting module 18 performs die-cutting operations on the sheet 1. Hence, the die-cutting tool may be configured to only contact the sheet 1 with cutting edges 54.

Hence, as both the scoring module 19 and the die-cutting module 18 can be configured to apply crease lines 2 onto different sides of the sheet 1, the direction of folding of the flat-packed box 1′ can be selected. The present converting machine 10 can thus be configured to arrange the printed motif 6 on either the inside or the outside surface of the final box 1′. This is done by changing the side of the sheet 1 on which the crease lines 2 are applied.

The combination of a first printing module 16 configured to print on a top side 1a of the sheet 1 and a second printing module 17 configured to print on a bottom side 1b of the sheet 1 makes it possible to produce a final box 1′ with a printed motif 6 on both the inside and the outside surfaces of the box 1′. Moreover, in combination with the separate scoring module 19 and die-cutting module 18, the direction of folding of the flat-packed box 1″ can be selected. In such a way, the converting machine 10 provides the operator with full flexibility when determining the usage of the printing modules 16, 17 and the positions (i.e. inside or outside) of the printed motifs 6.

The converting machine 10 according to the present invention is configured such that it is possible to select which printing module 16, 17 will print on the outside or the inside of the box. In such a way, the converting machine 10 can be provided with high resolution graphic anilox rolls (e.g. anilox rolls with small cell volumes) in one of the printing modules 16, 17 and a different anilox configuration (anilox with larger cell volume) in the other printing module 16,17.

The present converting machine 10 can thus be configured for the different types of boxes 1′ based on the already existing configuration of the anilox cylinders.

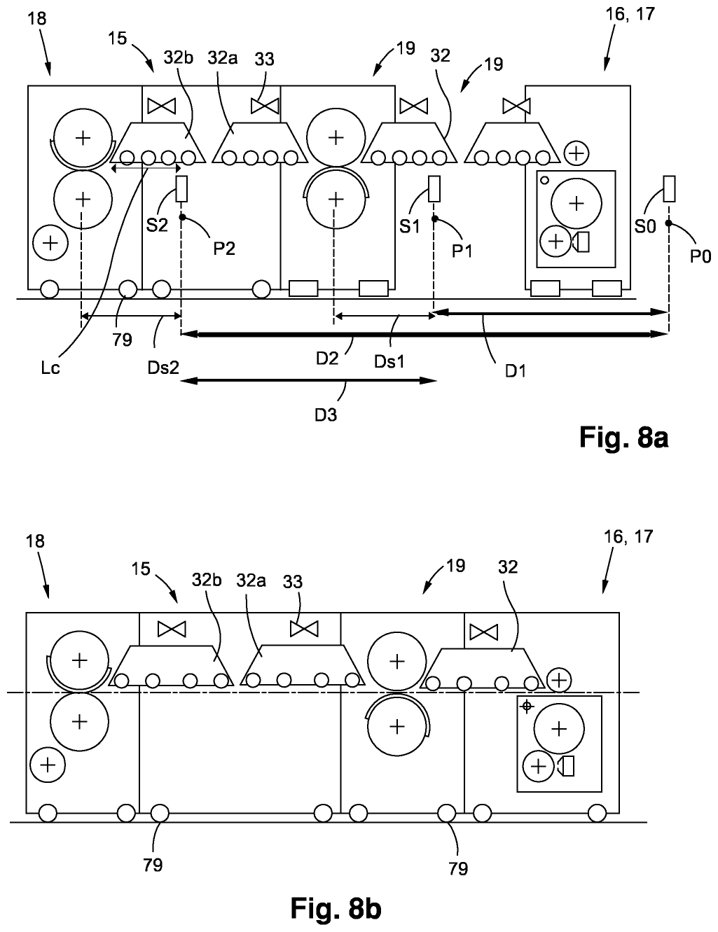

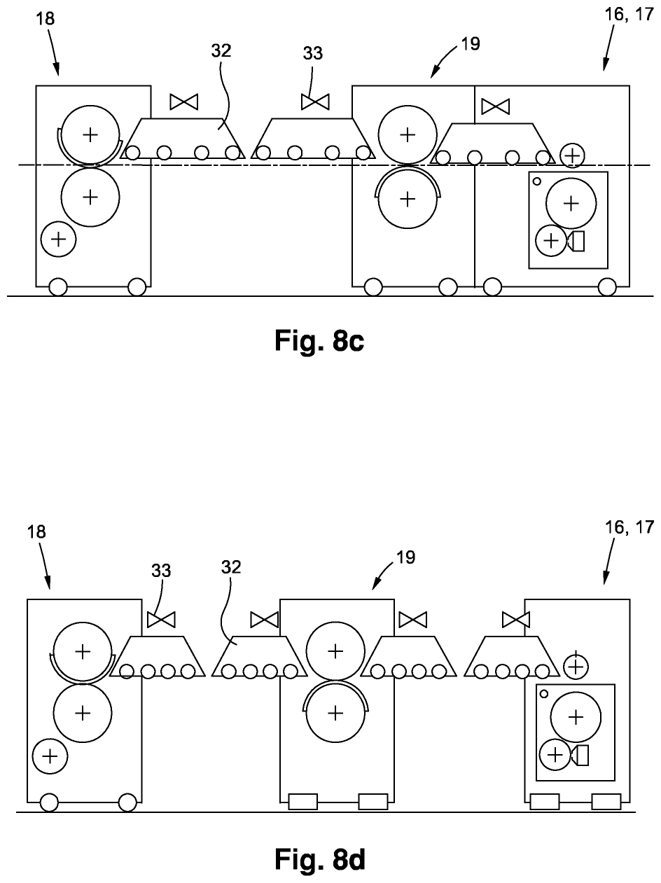

As illustrated in FIGS. 8a to 8d, some of the modules of the converting machine 10 can be arranged in a fixed or a mobile configuration. The fixed modules are fixedly connected to the floor of the workshop and may further have recessed machine accesses (such as trenches) arranged in the factory floor. The recessed access allows the operator to access machine parts from below. Mobile configurations can be designed by providing the modules with rollers such that they can be moved apart, such that lateral access to machine parts is enabled.

As illustrated in FIGS. 8a and 8b, at least the scoring module 19 is provided with rollers 79 or slide rails enabling a lateral displacement in the direction of transportation T.

In order to transport the sheet 1 between the scoring module 19 and the die-cutting module 18, at least one vacuum transfer 32 is arranged therebetween. Preferably, as illustrated in FIGS. 8a and 8b, a mobile separate vacuum transfer module 15 can be arranged between the scoring module 19 and the die-cutting module 18. It is also advantageous to provide the vacuum transfer module 15 with an inlet transfer 32a and an outlet transfer 32b. In such a way, a horizontal length of the vacuum transfer 32 can be longer than the length of the sheet 1, such that the position of the sheet 1 can be corrected over a sufficiently large distance.

At least one vacuum transfer 32 is located between the last flexographic printing module 16, 17 in the printing section 13 and the scoring module 19. The vacuum transfer 32 can be attached to the flexographic printing module. Depending on the required precision between the printed motif 6 and the crease lines 2 on the sheet 1, an additional second vacuum transfer 32 can be provided between the flexographic printing module and the scoring module 19.

As the scoring and die-cutting operations can be dissociated in the converting machine 10 of the present invention, it is advantageous to align the scoring and cutting operations in order to achieve a “mechanically” functioning flat-packed box 1″ which has the folding lines and cut edges located at the right positions. Ideally, the printing, creasing and die-cutting operations are all performed on predefined and calibrated positions on the sheet 1.

To control the alignment between the cutting and creasing operations, the converting machine 10 may further comprise a cutting and scoring register control system 80.

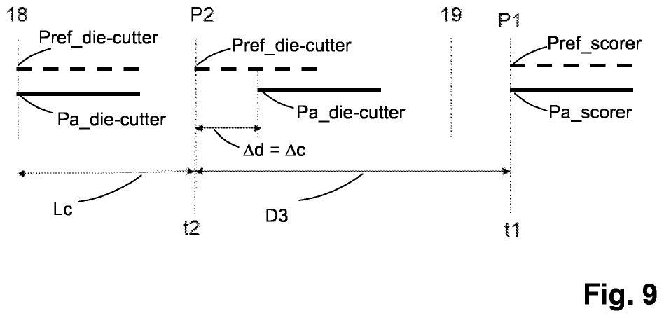

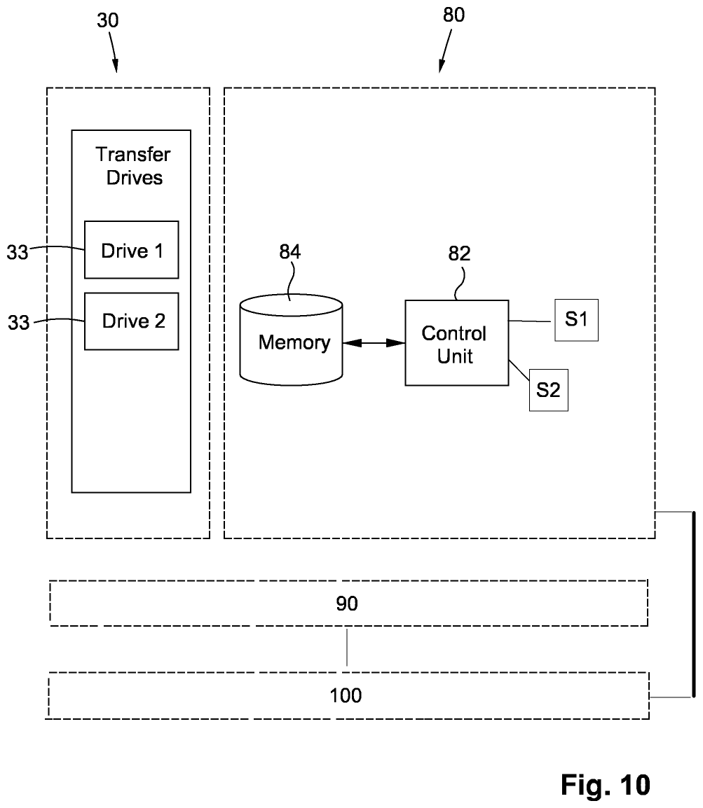

As illustrated in FIGS. 8a, 9 and 10, the cutting and scoring register control system 80 may be provided to ensure longitudinal alignment of the sheet 1 between the scoring module 19 and the die-cutting module 18. The longitudinal alignment of the sheet 1 is in the direction of transportation T. The cutting and scoring register control system 80 comprises a first sensor S1, a second sensor S2, a control unit 82 and a memory 84. The sensors S1 and S2 may be optical sensors which are configured to detect the passage of a front leading edge 3 of the sheet 1.

The converting machine 10 may further comprise a printing register control system 90 configured to align printed motifs from different flexographic printing assemblies 40. The printing register control system 90 may also align the printed motif from a digital inkjet printing module.

There is a variation in the time the feeder 14 discharges each sheet 1. Hence, the feeder 14 discharges each sheet 1 with a time difference in relation to a theoretical discharge time. The theoretical discharge time defines a theoretical register position.

The vacuum transfers 32 are arranged between each of the flexographic printing assemblies 40, the scoring module 19, and the die-cutting module 18. The vacuum transfers 32 are configured to provide a longitudinal correction to each sheet 1 based on input from a respective sensor arranged upstream of each of the printing modules 16, 17, 21 and printing assemblies 40, scoring module 19 and die-cutting module 18.

When providing a separate scoring module 19 and die-cutting module 18 as per the present invention, there is a need to ensure a high precision between the scoring and cutting operations. If there is a displacement between the cut lines, which form the overall shape of the sheet 1 and the crease lines 2, the sheet 1 cannot be folded properly to form a three-dimensional box or packaging container 1′.

In order to provide a high accuracy in the alignment between the scoring and cutting operations, a separate cutting and scoring register control system 80 can be provided. The separate cutting and scoring register control system 80 is independent from the printing register system 90. Hence, the cutting and scoring register control system 80 is not receiving and aligning to any initial printing reference position from the printing register system 90. This has an advantage of providing an improved accuracy by only aligning the creasing and cutting operations to each other and not carrying over required displacement corrections from the printing section 13.

The first sensor S1 is located downstream of a printing module 16, 17, 21 and upstream of the scoring module 19. The first sensor S1 may be configured to detect the passage of the front leading edge 3 of the sheet 1. From the detection time t1 of the passage of the front leading edge 3 at the first sensor S1, a central control system 100 of the converting machine 10 determines the actual scorer position Pa_scorer. This actual scorer position Pa_scorer is determined at the sensor location P1 located at a distance Ds1 upstream of the scoring module 19. The actual scorer position Pa_scorer is a position at a specific moment in time.

The second sensor S2 is located downstream of the scoring module 19 and upstream of the die-cutting module 1. The second sensor S2 is located at a distance Ds2 upstream of the die-cutting module 18.

A portion of the vacuum transfer 32b is located downstream of the second sensor S2. This portion corresponds to a correction distance Lc. This correction distance Lc extends from the second sensor location P2 to the outlet 35 of the vacuum transfer 32b.

From the detection time t2 of the front leading edge 3 provided by the second sensor S2, the central control system 100 of the converting machine 10 determines the actual die-cutter position Pa_die-cutter of the front leading edge 3 at the location P2 of the second sensor S2.

The actual scorer position Pa_scorer is defined as an initial reference position Pref_scorer for the die-cutting module 18. The initial reference position is a desired longitudinal position in the direction of transportation T at a predetermined moment in time and to which the sheet 1 should be aligned to. Hence,

Pref_scorer=Pa_scorer

A corresponding reference position P_ref_die-cutter for the die-cutting module 18 can then be calculated by the formula:

$$P\_ref \_die - cutter = Pa\_scorer + D 3$$

Where D3 is the distance between the first and second sensors S1, S2.

At the second sensor S2, a displacement distance Δd is determined from the difference between the actual die-cutter position Pa_die-cutter and the reference position for the die-cutter P_ref die-cutter.

Hence,

$$Δ d = Pa\_die - cutter - P\_ref \_die - cutter$$

The control unit 82 is configured to modify the speed of the at least one vacuum transfer 32b located downstream of the second sensor S2. In such a way, the longitudinal position of the sheet 1 can be modified in relation to the angular position of tools 52 in the die-cutting module 19. Hence, a corresponding displacement correction Δc corresponding to an elimination of the displacement distance Δd is provided by the at least one vacuum transfer unit 32b.

Hence,

Δc=Δd

The at least one vacuum transfer 32b located downstream of the second sensor S2 is preferably provided with a separate drive 33. In such a way, the acceleration and transportation speed of the vacuum transfer 32b can be independently modified. The sheet 1 can thus be given a correction Δc by accelerating or decelerating the sheet 1 over the correction distance Lc.

When an operator uses the present converting machine 10, the converting machine 10 is partly configured (i.e. set up) based on the quality requirements of the final box 1′. These quality requirements typically include characteristics such as color codes, required resolutions etc. The quality requirements may be specified in pdf printing files. The pdf printing files show the dimensions of the box 1′ and the required size of the sheets 1 to be placed in the feeder. The printing files also indicates the colors, order of colors and an indication of the required anilox cylinders 45 for the box 1′.

The flexographic printing cylinders 42 in flexographic printing module 16, 17 configured to print on a bottom side of the sheet have the anilox cylinders 45 mounted underneath the transportation path P of the sheet 1. Anilox cylinders 45 mounted underneath the transportation path P can be changed by an automatic system, such as the one described in the patent application WO20169256 A1, which is hereby integrated into this application in its entirety. As described in WO20169256 A1, a carriage travels through the printing module 16, 17.

Additionally, a storage space for anilox cylinders 45 can be provided under each flexographic printing module.

The task of changing anilox cylinders 45 arranged above the transportation path P in a flexographic printing module is more complicated, as this often involves at least two operators and a pulley/crane.

With the present converting machine 10, the printing module 16, 17 configured to print the sheet 1 from below may advantageously be used for the high-resolution print, regardless of if the print will be on the inside or the outside of the box 1′. In such a way, the need for changing the anilox configuration when changing from a high-resolution outside printed box to a high-resolution inside printed box is reduced. Instead, the operator simply changes the configuration of the scoring module 19 and the die-cutter module 18 to determine which printing module 16, 17 and thus which group of anilox rolls should be used for each side of the sheet 1.

Hence, the folding direction of the box 1′ can be changed in order to modify the location of the print.

The converting machine interface 11 may be configured to display the actual configuration of each anilox roll in each printing module 16, 17. Optionally, the converting machine 10 may also indicate the characteristics of the available anilox cylinders 45 in the storage position. As previously explained, the storage position may be located under each flexographic printing module 16, 17.

1. A converting machine for producing flat-packed or folding of boxes from sheets, the converting machine being configured to transport the sheets in a direction of transportation and wherein the converting machine comprises:
a first printing module configured to print on one of a first side and a second side of the sheet,
a die-cutting module comprising a counter-cylinder, and a tool-holder cylinder configured to connect to a first die-cutting tool provided with cutting edges, and wherein the die-cutting module is configured to apply cut lines to the first side of the sheet, and
a scoring module comprising a counter cylinder, and a tool-holder cylinder configured to connect to a scoring tool provided with creasing edges, the scoring module being configured to apply crease lines on a second side of the sheet.

2. The converting machine according to claim 1, wherein the scoring module can be disabled and the die-cutting module is further configured to connect to a second die-cutting tool which is configured to apply cut lines and crease lines onto the first side of the sheet, such that crease lines can be applied on either side of the sheet.

3. The converting machine according to claim 1, wherein the die-cutting module is located downstream of the scoring module in the direction of transportation.

4. The converting machine according to claim 1, wherein the scoring module comprises a structural frame having a first side frame portion and a second side frame portion, and wherein the side frames portions are configured to receive shafts of the tool-holder cylinder and the counter cylinder.

5. The converting machine according to claim 1, wherein the tool-holder cylinder of the die-cutting module is located vertically above a transportation path of the sheet.

6. The converting machine according to claim 5, wherein the tool-holder cylinder of the scoring module is located vertically below the transportation path of the sheet.

7. The converting machine according to claim 1, wherein the tool-holder cylinder of the scoring module comprises attachment brackets for attaching the scoring tool.

8. The converting machine according to claim 7, wherein the scoring tool is a die in a form of a sleeve, configured to be attached around a circumferential surface of the tool-holder cylinder.

9. The converting machine according to claim 1, wherein the scoring tool only comprises creasing edges.

10. The converting machine according to claim 1, wherein the counter-cylinder of the scoring module is provided with a resilient surface material configured to contact the creasing edges of the scoring tool.

11. The converting machine according to claim 1, wherein the first printing module is a flexographic printing module configured to print on bottom surface of the sheet.

12. The converting machine according to claim 1, wherein the first printing module is a flexographic printing module configured to print on top surface of the sheet.

13. The converting machine according to claim 1, wherein the first printing module is an ink-jet printing module.

14. The converting machine according to claim 11, wherein the converting machine further comprises a second printing module configured to print on a second side of the sheet, which is different from the side of the sheet printed by the first printing module.

15. The converting machine according to claim 14, wherein the converting machine further comprises a third printing module configured as an inkjet printing module, and which is preferably configured to print on a top surface of the sheet.

16. The converting machine according to claim 1, further comprising:
a conveying system comprising a plurality of vacuum transfers and a cutting and scoring register control system, the cutting and scoring register control system comprising a first sensor and a second sensor, a control unit and a memory,
wherein the first sensor is located upstream of the scoring module at a first sensor position and the second sensor is located upstream of the die-cutting module at a second sensor position,
wherein the cutting and scoring register control system is configured to determine from a detection time provided by the first sensor, an actual scorer position of a front leading edge of the sheet at the first sensor position and define said actual position as an initial reference position for the sheet, the system being further configured to determine based on the initial reference position, a corresponding die-cutter reference position for the front leading edge at the second sensor location,
wherein the control unit is configured to retrieve a detection time of the front leading edge from the second sensor and determine an actual position of the front leading edge of the sheet at the second sensor location, and
wherein the control unit is configured to determine a displacement distance from a difference between the actual die-cutter position and the die-cutter reference position, the control unit being further configured to modify a speed of at least one vacuum transfer among the plurality of vacuum transfers to provide a longitudinal position correction to the sheet between the scoring module and die-cutting module.

17. A system comprising:
a converting machine comprising a first printing module configured to print on one of a first side and a second side of a sheet,
a die-cutting module comprising a counter-cylinder and a tool-holder cylinder,
a scoring module comprising a counter cylinder and tool-holder cylinder,
a first die-cutting tool configured to connect to the tool-holder cylinder of the die-cutting module and wherein the first die-cutting tool is only provided with cutting edges,
a second die-cutting tool configured to connect to the tool-holder cylinder of the die-cutting module and wherein the second die-cutting tool is provided with cutting edges and creasing edges, and
a first scoring tool configured to connect to the tool-holder cylinder of the scoring module and provided with creasing edges.

18. The system according to claim 17, wherein the first printing module is configured to print on the first side of the sheet and wherein the system further comprises a second printing module configured to print on the second side of the sheet.
